(19) United States
(12) Patent Application Publication
(10) Pub. No.: US 2020/0390130 A1
(43) Pub. Date: Dec. 17, 2020

(54) Processing method for miscellaneous beans without soaking

(71) Applicant: Jiangnan University, Wuxi (CN)

(72) Inventors: Yongfu LI, Wuxi (CN); Min JIE, Wuxi (CN); Feng SHI, Wuxi (CN); Jinrong HUANG, Wuxi (CN); Siyu HUANG, Wuxi (CN); Zhengxing CHEN, Wuxi (CN)

(21) Appl. No.: 17/000,414

(22) Filed: Aug. 24, 2020

(30) Foreign Application Priority Data
Aug. 29, 2019 (CN) 2019108079508

(51) Int. Cl. A23L 11/00; A23L 5/30

(52) U.S. Cl. CPC A23L 11/01; A23V 2002/00; A23L 5/30

(57) ABSTRACT

The disclosure herein discloses a processing method of soaking-free mixed beans, and belongs to the technical field of deep processing of grains. By performing a combination of water supplementing and high-temperature fluidization processing on the mixed beans, embryos of the mixed beans slightly crack from one side by a width of 0.5-1 mm, and the diameter of capillary pores among cells in grains is increased by two times or more; meanwhile, due to processing, the internal structure of the grains of the mixed beans becomes loose, integrity of cell walls is damaged, starch is partly gelatinized, and due to those changes, the mixed beans have remarkably increased water absorbability and remarkably decreased cooking hardness, and thereby effectively solving the problems that the mixed beans have difficulty in absorbing water, need to be cooked for a long time, have high hardness and poor taste and can hardly be consumed as staple food, realizing the objective of cooking the mixed beans well along with rice without soaking the mixed beans, and promoting the consumption of the mixed beans as staple food. The mixed beans have a soft and delicate taste, no granular texture but a strong bean fragrance after being cooked along with rice. The processing method also remarkably reduces the content of raffinose in the mixed beans and can effectively solve the flatulence problem occurring after the mixed beans are eaten.

### TECHNICAL FIELD

The disclosure relates to a processing method for miscellaneous beans without soaking, and belongs to the technical field of deep processing of grains.

### BACKGROUND

In recent years, there are problems in dietary structure, such as unbalanced nutrition and deficient proportion of coarse cereals as staple food, and many chronic diseases are closely related to the staple food structure of people, which has aroused our great concern. Traditional staple food needs structural adjustment, while changes of dietary structure can effectively prevent the generation of chronic diseases and improve the sub-health status of residents. The 2016 dietary guidelines for Chinese residents suggest that food should be diversified with cereals as staple food and a combination of coarse grains and refined grains, and each person should consume 50-150 g of whole grains and mixed bean type staple food every day. Mixed beans, such as red beans, small red beans, adzuki beans, mung beans and cowpeas, have rich nutrients. However, the mixed beans usually have poor water absorbability due to their hard textures, dense and thick skin and small embryos, so they need to be soaked for a long time and cooked for a long time before being eaten.

Small red beans, for example, are a kind of small coarse cereals with high protein, low fat and various nutrients, are rich in ferrum, calcium, phosphorus and other mineral elements, have the functions of enriching blood, detoxifying toxin and treating edema, can prevent chronic diseases, and are a kind of medicine and food homologous food. The small red beans have a high content of lysine in protein and should be mixed with cereal food into bean rice or bean porridge for eating. With the increasing recognition and acceptance of the nutritional and health value of coarse cereals, how small red beans are completely integrated into the daily staple food has attracted more and more attention from academic circles and consumers. “Whole grain” red beans keep functional substances in red bean skin after being cooked in a form of complete beans, and provide high-quality “whole food nutrient” food for people. However, the small red beans have poor water absorbability due to their hard textures, dense and thick skin and small embryos and should be soaked for a long time and cooked for a long time before being eaten, and they are not convenient to eat, so the requirements of modern consumers for food taste and eating convenience cannot be met.

### SUMMARY

The disclosure provides a processing method of soaking-free mixed beans. By performing water supplementing and high-temperature fluidization processing on the mixed beans, the mixed beans have remarkably increased water absorbability and remarkably decreased cooking hardness, thereby effectively solving the problems that the mixed beans have difficulty in absorbing water, need to be cooked for a long time, have high hardness and poor taste and can hardly be consumed as staple food. The mixed beans obtained through the processing method of the present disclosure can be cooked well along with rice without being soaked; and meanwhile, the processed mixed beans have a soft and delicate taste, no granular texture but a strong bean fragrance after being cooked along with rice. The processing method provided by the present disclosure also remarkably reduces the content of raffinose in the mixed beans and can effectively solve the flatulence problem occurring after the mixed beans are eaten.

The disclosure discloses a processing method for miscellaneous beans without soaking. The method comprises the steps of supplementing water to mixed beans, and then performing high-temperature fluidization processing to obtain a finished product of the soaking-free mixed beans.

In one example of the disclosure, the mixed beans include red beans, small red beans, adzuki beans, mung beans and cowpeas.

In one example of the disclosure, the method comprises the following steps:

(1) supplementing water, wherein the water is supplemented to mixed bean raw materials;

(2) performing high-temperature fluidization processing, wherein the mixed bean raw materials subjected to water supplementing in step (1) are fed into a reactor for high-temperature fluidization processing, and a fluidization temperature of high-temperature fluidization processing is 225-245° C.; and

(3) cooling and packaging the mixed beans subjected to high-temperature fluidization processing in step (2) to obtain a product.

In one example of the disclosure, a mass ratio of water for supplementation to mixed beans is (1.5-3.5):10.

In one example of the disclosure, a fluidization temperature of high-temperature fluidization processing is 225-245° C.

In one example of the disclosure, a feeding speed in step (2) is 32-77 kg/h.

The disclosure discloses the soaking-free mixed beans prepared through the method.

The disclosure discloses application of the mixed beans to rice cooking, porridge cooking, soup stewing, stuffing making and bean product making.

The disclosure discloses a method of preparing coarse cereal rice, stuffing or bean products, wherein the above mixed beans serve as a raw material.

In one example of the disclosure, the mixed beans do not need to be soaked in the application process.

The disclosure discloses a method of removing raffinose from the mixed beans, and the method comprises the step of performing high-temperature fluidization processing on the mixed beans, wherein a fluidization temperature as a high-temperature fluidization processing condition is 225-245° C.

The disclosure has the following beneficial effects.

(1) The small red beans have remarkably increased water absorbability and remarkably decreased cooking hardness, thereby effectively solving the problems that the small red beans have difficulty in absorbing water, need to be cooked for a long time, have high hardness and poor taste and can hardly be consumed as staple food, realizing the objective of cooking the small red beans well along with rice without soaking the small red beans, and promoting the consumption of the small red beans as staple food, and the small red beans have a soft and delicate taste, no granular texture but a strong bean fragrance after being cooked along with rice.

(2) By means of the disclosure, embryos of the small red beans slightly crack from one side by a width of about 0.5-1 mm.

(3) By means of the disclosure, the content of a flatulence factor (raffinose) in the small red beans can be remarkably reduced by 5.47% from 10.83% to 5.36%.

(4) No food additives are added, and the shelf life can reach twelve months or longer.

(5) The method of the disclosure is simple in step, the water absorbability and the cooking hardness of the small red beans subjected to a combination of water supplementing and high-temperature fluidization processing are more outstanding compared with those of small red beans subjected to individual water supplementing and individual fluidization processing, it is shown that water supplementing and high-temperature fluidization processing support each other and supplement each other in function, and the obtained product has hardness close to that of white rice and can be cooked well along with white rice.

(6) The product has no obvious differences in appearance and basic nutrients before and after the small red beans are processed.

### BRIEF DESCRIPTION OF FIGURES

FIG. 1 is a scanning electron microscope image of a cross section of a product obtained in example 3 of the disclosure.

FIG. 2 is a scanning electron microscope image of a cross section of a small red bean raw material of the disclosure.

### DETAILED DESCRIPTION

Preferred examples of the disclosure are described as follows and should be understood to better explain but not to limit the disclosure.

1. A Measuring Method of Water Absorbability

5 g (to the accuracy of 0.0001 g) of small red beans are added into 50-mL centrifugal tubes respectively, m₁ is recorded, 35 mL of deionized water is added, the centrifugal tubes are put into a 30° C. constant-temperature water bath pot, draining is performed 0.5 hours, 1.0 hour, 1.5 hours, 2.0 hours, 2.5 hours, 3 hours, 3.5 hours and 4 hours later, water on the surfaces of the small red beans is wiped out with water absorbing paper, the mass of the small red beans is weighed, m₂ is recorded, and the water absorbability is calculated. Three parallel examples are set up in each test. The water absorbability/%=(m₂−m₁)*100/m₁.

2. A Measuring Method of Cooking Hardness

The small red beans are sorted out of coarse cereal rice, and the hardness of the small red beans is measured through a texture analyzer. A TPA mode has parameters: speeds before, during and after measurement of 1 mm/s, 1 mm/s, and 5 mm/s respectively, trigger force of 5.0 g, a compression degree of 75%, a time interval between twice of compression of 3.0 s, and a probe of P/35. Ten parallel tests are performed for each sample, the maximum and the minimum are removed, and then the average is obtained. A measuring method of hardness of rice in coarse cereal rice is the same as above.

3. A Measuring Method of Cross-Sectional Form of Small Red Beans

The cross-sectional form of the small red beans is observed with a scanning electron microscope (SEM), the small red beans are split along a transverse central plane, vacuum metal spraying is performed on cross sections, scanning and observing are performed at an acceleration voltage of 5 kV, and pictures are taken.

4. A Measuring Method of Content of Raffinose

(1) Standard samples are prepared, where 250 mg of raffinose is accurately weighed, dissolved in 10 mL of pure water first and then fixed to a constant volume of 25 mL by 15 mL of acetonitrile to form a stock solution with a concentration of 10 g/L. A certain volume of stock solution is accurately taken and transferred into 10-mL volumetric flasks and fixed to a constant volume by a flowing phase to prepare the standard samples with a series of concentrations, and the solutions are filtered through a 0.45-μ needle type filter for use.

(2) Samples are prepared, where 1.000 g of soybean powder sample passing through a 100-mesh sieve is accurately weighed, dissolved in 10 mL of 70% ethyl alcohol and extracted through a microwave digestion method for 2 min, and a digestion solution is centrifuged for 10 min through a high-speed refrigerated centrifuge at a rotating speed of 4,000 r/min. Supernate is taken to be filtered through a 0.45-μ filtration membrane, and 10 μL of sample solution is taken for HPLC detection.

A Hypersil-amino column (4.6 mm*150 mm, 5 am); a flowing phase (ultrasonic oscillation degassing for 20 min), the flowing phase uses an acetonitrile-water system (60:40, v/v), and a flowing speed is 1 mL/min; a column temperature is 35° C.; a sample size is 10 μL; and a detecting system is an RI 2000 differential refraction detector.

5. Measuring of Contents of Water, Fat, Starch, Amylose and Protein in Small Red Beans

The contents of water, fat, starch, amylose and protein in the small red beans are measured according to the methods specified in GB 5009.3-2016, GB 5009.6-2016, GB 5009.9-2016, GB 15683-2008 and GB 5009.5-2016.

### Example 1

A processing method of soaking-free small red beans comprises the following technological steps:

(1) firstly, supplementing water to a small red bean raw material according to 10:2 (small red bean/water, m/m);

(2) then, performing fluidization processing on the small red bean raw material at a fluidization temperature of 235° C., and a feeding speed of 47 kg/h;

(3) performing cooling and packaging to obtain a product; and

(4) finally, thoroughly washing the product and rice, adding tap water according to a certain material-water mass ratio, performing cooking for a period of time, and preserving heat for a certain period of time to obtain small red bean coarse cereal rice, where a ratio of small red beans to rice is 1:4, the material-water ratio is 1:1.9, cooking time is 40 min, and heat preserving time is 20 min. Test results of water absorbability, raffinose content and cooking hardness of the product can be seen in table 1.

### Example 2

A processing method of soaking-free small red beans comprises the following technological steps:

(1) firstly, supplementing water to a small red bean raw material according to 10:1.5 (small red bean/water, m/m);

(2) then, performing fluidization processing on the small red bean raw material at a fluidization temperature of 225° C., and a feeding speed of 77 kg/h;

(3) performing cooling and packaging to obtain a product; and

(4) finally, thoroughly washing the product and rice, adding tap water according to a certain material-water mass ratio, performing cooking for a period of time, and preserving heat for a certain period of time to obtain small red bean coarse cereal rice, where a ratio of small red beans to rice is 1:4, the material-water ratio is 1:1.9, cooking time is 40 min, and heat preserving time is 20 min. Test results of water absorbability, raffinose content and cooking hardness of the product can be seen in table 1.

### Example 3

A processing method of soaking-free small red beans comprises the following technological steps:

(1) firstly, supplementing water to a small red bean raw material according to 10:3.5 (small red bean/water, m/m);

(2) then, performing fluidization processing on the small red bean raw material at a fluidization temperature of 245° C., and a feeding speed of 32 kg/h;

(3) performing cooling and packaging to obtain a product; and

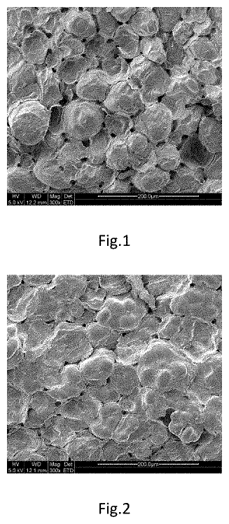

(4) finally, thoroughly washing the product and rice, adding tap water according to a certain material-water mass ratio, performing cooking for a period of time, and preserving heat for a certain period of time to obtain small red bean coarse cereal rice, where a ratio of small red beans to rice is 1:4, the material-water ratio is 1:1.9, cooking time is 40 min, and heat preserving time is 20 min. Test results of water absorbability, raffinose content and cooking hardness of the product can be seen in table 1; and a scanning electron microscope image of a cross section structure of the product can be seen in FIG. 1.

It can be seen in FIG. 1 that since the compact linkage among starch particles is damaged by processing and the cross-sectional surface of the raw material is dense, the diameter and number of micro pores among part of adjacent cells on the cross-sectional surface of the small red beans processed by the disclosure are remarkably increased, the integrity of cell walls is damaged and the internal structure of grains becomes loose, which is a main reason of the easy-to-cook property of the product obtained in the disclosure.

### Comparative Example 1

A certain amount of small red bean raw material is taken without being processed. Test results of water absorbability, raffinose content and cooking hardness of the product can be seen in table 1, a cross section structure is observed through a scanning electron microscope, and the result can be seen in FIG. 2.

### Comparative Example 2

A processing method of soaking-free small red beans comprises the following technological steps:

(1) performing fluidization processing on a small red bean raw material at a fluidization temperature of 235° C., and a feeding speed of 47 kg/h;

(2) performing cooling and packaging to obtain a product; and

(3) finally, thoroughly washing the product and rice, adding tap water according to a certain material-water mass ratio, performing cooking for a period of time, and preserving heat for a certain period of time to obtain small red bean coarse cereal rice, where a ratio of small red beans to rice is 1:4, the material-water ratio is 1:1.9, cooking time is 40 min, and heat preserving time is 20 min. Test results of water absorbability, raffinose content and cooking hardness of the product can be seen in table 1.

### Comparative Example 3

A processing method of soaking-free small red beans comprises the following technological steps:

(1) firstly, supplementing water to a small red bean raw material according to 10:1 (small red bean/water, m/m);

(2) then, performing fluidization processing on the small red bean raw material at a fluidization temperature of 235° C., and a feeding speed of 47 kg/h;

(3) performing cooling and packaging to obtain a product; and

(4) finally, thoroughly washing the product and rice, adding tap water according to a certain material-water mass ratio, performing cooking for a period of time, and preserving heat for a certain period of time to obtain small red bean coarse cereal rice, where a ratio of small red beans to rice is 1:4, the material-water ratio is 1:1.9, cooking time is 40 min, and heat preserving time is 20 min. Test results of water absorbability, raffinose content and cooking hardness of the product can be seen in table 1.

### Comparative Example 4

A processing method of soaking-free small red beans comprises the following technological steps:

(1) firstly, supplementing water to a small red bean raw material according to 10:2 (small red bean/water, m/m);

(2) then, performing fluidization processing on the small red bean raw material at a fluidization temperature of 255° C., and a feeding speed of 47 kg/h;

(3) performing cooling and packaging to obtain a product; and

(4) finally, thoroughly washing the product and rice, adding tap water according to a certain material-water mass ratio, performing cooking for a period of time, and preserving heat for a certain period of time to obtain small red bean coarse cereal rice, where a ratio of small red beans to rice is 1:4, the material-water ratio is 1:1.9, cooking time is 40 min, and heat preserving time is 20 min. Test results of water absorbability, raffinose content and cooking hardness of the product can be seen in table 1.

### Comparative Example 5

A processing method of soaking-free small red beans comprises the following technological steps:

(1) firstly, supplementing water to a small red bean raw material according to 10:2 (small red bean/water, m/m);

(2) then, performing fluidization processing on the small red bean raw material at a fluidization temperature of 235° C., and a feeding speed of 92 kg/h;

(3) performing cooling and packaging to obtain a product; and

(4) finally, thoroughly washing the product and rice, adding tap water according to a certain material-water mass ratio, performing cooking for a period of time, and preserving heat for a certain period of time to obtain small red bean coarse cereal rice, where a ratio of small red beans to rice is 1:4, the material-water ratio is 1:1.9, cooking time is 40 min, and heat preserving time is 20 min. Test results of water absorbability, raffinose content and cooking hardness of the product can be seen in table 1.

### Comparative Example 6

A processing method of soaking-free small red beans comprises the following technological steps:

(1) firstly, supplementing water to a small red bean raw material according to 10:2 (small red bean/water, m/m); and

(2) then, thoroughly washing water-supplemented small red beans and rice, adding tap water according to a certain material-water mass ratio, performing cooking for a period of time, and preserving heat for a certain period of time to obtain small red bean coarse cereal rice, where a ratio of small red beans to rice is 1:4, the material-water ratio is 1:1.9, cooking time is 40 min, and heat preserving time is 20 min. Test results of water absorbability, raffinose content and cooking hardness of the product can be seen in table 1.

TABLE 1
Properties of small red beans

| | After-4 h-soaking | | |
|---|---|---|---|
| | water | Cooking | |
| Samples | absorbability/% | hardness/g | Raffinose mg/g |
| Example 1 | 88.01 | 1448 | 5.36 |
| Example 2 | 82.93 | 1670 | 5.50 |
| Example 3 | 83.50 | 1590 | 5.22 |
| Comparative | 14.56 | >5000 | 10.83 |
| example 1 | | | |
| Comparative | 23.99 | 4324 | 5.67 |
| example 2 | | | |
| Comparative | 78.20 | 2786 | 5.47 |
| example 3 | | | |
| Comparative | 93.38 | 1779 | 5.18 |
| example 4 | | | |
| Comparative | 76.21 | 2311 | 5.40 |
| example 5 | | | |
| Comparative | 35.90 | 4710 | 10.74 |
| example 6 | | | |

TABLE 2
Nutrients of small red beans

| Samples | Water/% | Fat/% | Starch/% | Amylose/% | Protein/% |
|---|---|---|---|---|---|
| Example 1 | 12.56 | 0.92 | 61.05 | 13.77 | 21.06 |
| Example 2 | 12.25 | 0.93 | 61.27 | 13.63 | 21.13 |
| Example 3 | 12.14 | 0.90 | 60.83 | 13.84 | 21.76 |
| Comparative | 12.77 | 0.87 | 61.25 | 13.71 | 21.19 |
| example 1 | | | | | |

It can be seen by comparing small red beans of examples 1, 2 and 3 with those of comparative example 1 that the water absorbability of the processed small red beans is improved from 14.56% to 80% or above, and the cooking hardness is reduced from 5000 g to 1448-1670 g. The cooking hardness of the small red beans of example 1 has no obvious difference from the cooking hardness (1367 g) of rice under same conditions, and basically the small red beans can be cooked well along with rice. It can be seen from comparative example 2 and comparative example 6 that if high-temperature fluidization is directly performed without water supplementing, the water absorbability and cooking hardness of obtained small red beans are not improved compared with those of a small red bean raw material; and likewise, if only water supplementing is performed without high-temperature fluidization processing, the water absorbability and cooking hardness of obtained small red beans are not improved compared with those of a small red bean raw material. On the other hand, compared with example 1, the water absorbability and cooking hardness of small red beans subjected to a combination of water supplementing and high-temperature fluidization processing are more outstanding compared with those of small red beans subjected to individual water supplementing and individual fluidization processing, and it is shown that water supplementing and high-temperature fluidization processing support each other and supplement each other in function. By observing comparative example 3, we can know that water needs to be supplemented by a proper amount, under a condition of low water supplementing amount, though the cooking hardness of small red beans subjected to fluidization processing is lowered, the small red beans cannot be cooked well along with rice. It can be seen from comparative example 4 that under a condition of high fluidization temperature, though the water absorbability and cooking hardness are improved, obtained small red beans undergo a darker color and a damaged grain form and appearance due to excessive processing. It can be seen from comparative example 5 that if a feeding speed is too high during high-temperature fluidization, processing will be insufficient and the cooking hardness of small red beans may not allow the small red beans to be cooked well along with rice.

Raffinose is a kind of soybean oligosaccharides, and it is the major ingredient that causes flatulence after beans are eaten. It can be seen from examples and comparative examples that after high-temperature fluidization processing, the content of raffinose is remarkably reduced from 10.83% to about 5%.

It can be known in table 2 that compared with unprocessed raw materials, nutrients of small red beans processed by the method of the disclosure are not changed. In addition, inventors prove through multiple experiments that the method of the disclosure is also suitable for red beans, adzuki beans, mung beans and cowpeas.

Preferred examples of the disclosure have been disclosed as above, but not for limiting the disclosure, modifications and variations can be made by those skilled in the art without departing from the spirit and scope of the disclosure, and thus the protection extent of the disclosure should take definition of claims as standard.

What is claimed is:

1. A processing method of soaking-free mixed beans, comprising the steps of supplementing water to mixed beans, and then performing high-temperature fluidization processing to obtain a finished product of the soaking-free mixed beans, wherein a fluidization temperature of high-temperature fluidization processing is 225-245° C.

2. The method according to claim 1, wherein the mixed beans comprise red beans, small red beans, adzuki beans, mung beans and cowpeas.

3. The method according to claim 1 or 2, comprising the following steps:
(1) supplementing water, wherein the water is supplemented to mixed bean raw materials;
(2) performing high-temperature fluidization processing, wherein the mixed bean raw materials subjected to water supplementing in step (1) are fed into a reactor for high-temperature fluidization processing, and a fluidization temperature of high-temperature fluidization processing is 225-245° C.; and
(3) cooling and packaging the mixed beans subjected to high-temperature fluidization processing in step (2) to obtain a product.

4. The method according to claim 3, wherein a mass ratio of water for supplementation to the mixed beans is (1.5-3.5):10.

5. The method according to claim 3, wherein a feeding speed in step (2) is 32-77 kg/h.

6. The method according to claim 3, comprising the following technological steps:
(1) firstly, supplementing water to a small red bean raw material, wherein a mass ratio of water for supplementation to small red beans is 10:2;
(2) then, performing fluidization processing on the small red bean raw material at a fluidization temperature of 235° C., and a feeding speed of 47 kg/h; and
(3) performing cooling and packaging to obtain a product.

7. The method according to claim 3, comprising the following technological steps:
(1) firstly, supplementing water to a small red bean raw material, wherein a mass ratio of water for supplementation to small red beans is 10:1.5;
(2) then, performing fluidization processing on the small red bean raw material at a fluidization temperature of 225° C., and a feeding speed of 77 kg/h; and
(3) performing cooling and packaging to obtain a product.

8. The method according to claim 3, comprising the following technological steps:
(1) firstly, supplementing water to a small red bean raw material, wherein a mass ratio of water for supplementation to small red beans is 10:3.5;
(2) then, performing fluidization processing on the small red bean raw material at a fluidization temperature of 245° C., and a feeding speed of 32 kg/h; and
(3) performing cooling and packaging to obtain a product.

9. Soaking-free mixed beans prepared through the processing method according to any one of claims 1-8.

10. A method of preparing coarse cereal rice, stuffing or bean products, wherein the mixed beans according to claim 9 serve as a raw material.

11. The method according to claim 10, wherein the mixed beans do not need to be soaked in the method.
